(19) United States
(12) Patent Application Publication
(10) Pub. No.: US 2009/0107108 A1
(43) Pub. Date: Apr. 30, 2009

(54) NACELL FOR BYPASS ENGINE WITH HIGH BYPASS RATIO

(76) Inventors: Guy Bernard Vauchel, Le Havre (FR); Jean Fabrice Marcel Portal, Le Havre (FR); Laurent Albert Blin, Sainte Adresse (FR); Christophe Thorel, Le Havre (FR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/297,485

(22) PCT Filed: Apr. 12, 2007
(86) PCT No.: PCT/FR2007/000616

§ 371 Date: Oct. 17, 2008

(30) Foreign Application Priority Data
May 10, 2006 (FR) 0604113

(51) Int. Cl. F02K 3/02

(52) U.S. Cl. 60/226.2; 415/208.1

(57) ABSTRACT

This invention relates to a nacelle for bypass engine with a high bypass ratio comprising an interior flow channel for a secondary flow generated by the bypass engine and having an external structure provided with a reverse thrust device capable of alternately shifting from a closed position in which it enables circulation of the direct-jet secondary flow inside the interior channel, to an open position in which it uncovers an opening in the external structure so as to enable reorientation of the secondary flow in an angled flow via activation of the reverse thrust means; in open position, the reverse thrust device partially blocks the interior channel so as to provide a leakage section therein, enabling circulation of a controlled leakage flow, said nacelle being characterized in that, when the thrust reversal device is in open position and has an angled-jet reversal section and a leakage section through the interior channel the sum of which is substantially equal to a direct-jet secondary flow discharge section, when the thrust reversal device is in closed position.

The present invention relates to a nacelle for a bypass turbine engine with a high bypass ratio comprising an inner duct through which there flows a secondary stream generated by the turbine engine and which has an external structure equipped with a thrust reverser device.

An airplane is propelled by a number of turbine engines each housed in a nacelle that also contains a collection of auxiliary actuating devices associated with the operation thereof and performing various functions when the turbine engine is running or not running. These auxiliary actuating devices include in particular a mechanical system for actuating thrust reversers.

A nacelle generally has a tubular structure comprising an air intake upstream of the turbine engine, a central section intended to surround a fan of the turbine engine, a downstream section housing the thrust reverser means and intended to surround the combustion chamber of the turbine engine, and generally ends in a jet pipe the outlet of which is situated downstream of the turbine engine.

Modern nacelles are designed to house a bypass turbine engine capable, by means of the blades of the rotating fan, of generating a hot air stream (also known as the primary stream) from the combustion chamber of the turbine engine, and a cold air stream (secondary or bypass stream) which flows around the outside of the turbine engine through an annular passage, also known as a duct, formed between a shroud of the turbine engine and an internal wall of the nacelle. The two air streams are ejected from the turbine engine via the rear end of the nacelle.

The purpose of a thrust reverser is, when an airplane is coming in to land, that of improving the ability of said airplane to brake by redirecting forward at least some of the thrust generated by the turbine engine. During this phase, the reverser closes off the cold stream duct and directs this cold stream toward the front of the nacelle, thereby generating a reverse thrust which combines with the braking of the airplane wheels.

The means employed to achieve this reorientation of the cold stream vary according to the type of reverser. However, in all instances, the structure of a reverser comprises moving cowls that can be moved between, on the one hand, a deployed position in which they open up, within the nacelle, a passage intended for the deflected stream and, on the other hand, a retracted position in which they close off this passage. These cowls may perform a deflecting function or may simply activate other deflecting means.

In the case of a cascade-type thrust reverser that has cascades of vanes, the air stream is reoriented by cascades of deflection vanes, the cowl having the simple function of sliding to uncover or re-cover these cascades. Additional blocking doors, activated by the sliding of the cowling, are generally able to close off the duct downstream of the cascade so as to optimize the reorientation of the cold stream.

It is possible to avoid having to fit blocking doors by adapting the shape of the duct such that the latter is S-shaped, that is to say such that the engine cowling has a bulge that matches the interior wall of the nacelle formed by the cowling at this point. The height of the bulge is calculated so that the reverser cowling by itself closes off the duct as it slides into the reverser-open position. In this case, the cascade reverser is known as a natural blockage cascade reverser, the sliding cowling naturally blocking off the cold stream duct by virtue of its shape and of the shape of said duct.

A reverser of such a type is described in documents FR 2 132 380 and U.S. Pat. No. 4,232,516 for example.

Modern powerplants are tending toward the use of bypass turbine engines with high bypass ratios, that is to say of turbine engines that generate a cold air stream flow rate very much higher than the hot air stream flow rate. Typically, the flow rate of the cold stream may be as much as ten times that of the hot air stream. As a result, a nacelle associated with a turbine engine such as this has a fan duct and a cold stream duct of a large size suited to such a flow rate. One of the direct consequences of this is therefore an increase in the size of the nacelle and in the mass of the powerplant.

Combining a turbine engine with a high bypass ratio with a natural blockage cascade-type reverser system heightens this phenomenon by requiring there to be a larger bulge in the duct, thus increasing by a corresponding amount the size of the associated recess in the nacelle cowling, with repercussions on the external wall of the nacelle, it being necessary to have a greater separation between the internal wall and the external wall in order to account for this deeper recess. This results in a greater overall diameter of the nacelle, which diameter may become problematic owing to the tendency that aircraft manufacturers have to fit airplanes with shorter landing gear, these airplanes having shorter clearances under their wings.

Document WO 96/19656 describes a nacelle capable of alleviating some of these problems. To do that, a nacelle according to WO 96/19656 comprises a thrust reverser device that only partially blocks the inner duct so as to leave therein a leakage cross section allowing a controlled leakage rate to flow.

However, there is still the need for further improvements to the advantages of such a nacelle.

To achieve this, the present invention consists in a nacelle for a bypass turbine engine with a high bypass ratio comprising an inner duct through which there flows a secondary stream generated by the turbine engine and which has an external structure equipped with a thrust reverser device capable alternately of switching from a closed position in which it allows the secondary stream to flow through the inner duct as a direct jet, into an open position in which it uncovers an opening in the external structure so as to allow the secondary stream to be redirected into a deflected jet through activation of thrust reverser means, the thrust reverser device, in the open position, partially blocking the inner duct so as to create therein a leakage cross section allowing a controlled leakage flow, said nacelle being characterized in that, when in the open position, the thrust reverser has a cross section for reversal into a deflected jet and a leakage cross section for leakage through the inner duct the sum of which is substantially equal to a cross section for discharging the secondary stream as a direct jet when the thrust reverser is in the closed position.

Thus, by providing a leakage cross section when the thrust reverser is in the open position, only a fraction of the secondary or bypass stream is reversed, thus making it possible to reduce the size and mass of the thrust reverser means and, more generally, of the nacelle as a whole.

Specifically, as explained previously, one of the characteristics of nacelles for bypass turbine engines with high bypass ratios is that they are large in size, thus generating high levels of ram drag. This ram drag has a natural tendency to brake the airplane. In spite of this natural braking phenomenon, it is nonetheless necessary to use a thrust reversal system to assist with braking. However, all that is now required is for thrust reversal to be optimized in order merely to brake the airplane taking a substantial ram drag into consideration.

As a result, there is no longer any need to reverse practically all of the secondary stream, and installing a leakage cross section allows part of the secondary stream to continue to escape as a direct jet while only the remaining fraction is reversed in order to produce the required reverse thrust. The leakage cross section thus installed is controlled, that is to say has a determined cross section calculated to allow the reversal of a fraction of the secondary stream that is high enough to brake the airplane.

Because the amount of air to be reversed is smaller, it is possible to reduce the dimensions of the thrust reverser means, such as deflection cascades in the case of cascade-type thrust reversers. Furthermore, the space needed to house the thrust reverser means when the thrust reverser is in the closed position can also be reduced, thus allowing substantial reductions in the overall size of the nacelle.

In addition, by exhibiting, when the thrust reverser is in the open position, a cross section for reversal into a deflected jet and a cross section for leakage through the inner duct, the sum of which is substantially equal to a cross section for discharge of the secondary stream as a direct jet when the thrust reverser is in a closed position, the total cross section given over to the passage of the secondary stream remains substantially constant in the thrust-reversal phase and in the direct-jet phase, thus avoiding any increase or decrease in the pressure of the secondary stream through the inner duct.

As a preference, the reversal cross section is obtained by moving a moving cowl of reduced thickness and capable, in the closed position, of ensuring the external and internal aerodynamic continuity of the nacelle.

Advantageously, the nacelle is intended to house a turbine engine with a bypass ratio of close to ten, and in that the leakage cross section is calculated so that the thrust reverser, in the open position, provides a reverse thrust substantially equal to twenty percent of the direct-jet thrust obtained when the reverser is in the closed position.

Advantageously also, the leakage cross section, when the thrust reverser is in the open position, represents approximately thirty percent of the discharge cross section for direct jet discharge.

As a preference, the thrust reverser is a cascade-type thrust reverser. Advantageously, the thrust reverser is a natural blockage cascade reverser.

Advantageously, the leakage cross section is obtained by reducing the cross section of the inner duct as a moving cowl with which the thrust reverser device is equipped is moved.

According to a first alternative form of embodiment, the inner duct has a bulge situated downstream of the moving cowl in the open position.

According to a second alternative form of embodiment, the inner duct has a bulge situated substantially in the region of an upstream edge of the moving cowl in the open position.

The implementation of the invention will be better understood from the detailed description given hereinafter with reference to the attached drawing in which:

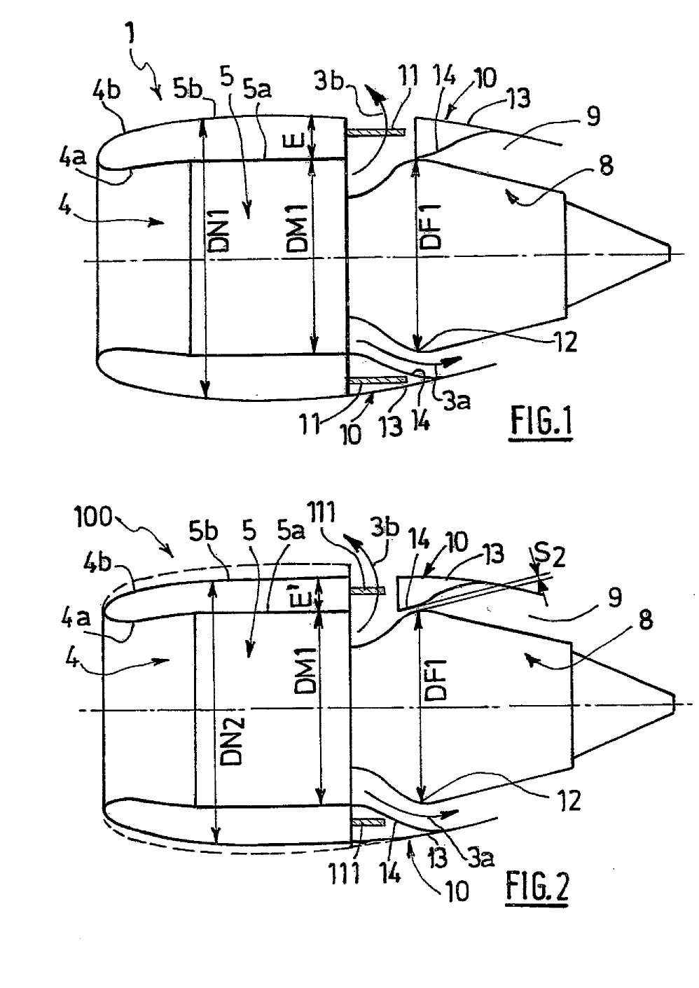

FIG. 1 is a schematic depiction in longitudinal section of a nacelle of a bypass turbine engine with a high bypass ratio according to the prior art, equipped with a natural blockage cascade-type thrust reverser.

FIG. 2 is a schematic depiction in longitudinal section of a nacelle of a bypass turbine engine with a high bypass ratio according to a first alternative form of embodiment of the invention.

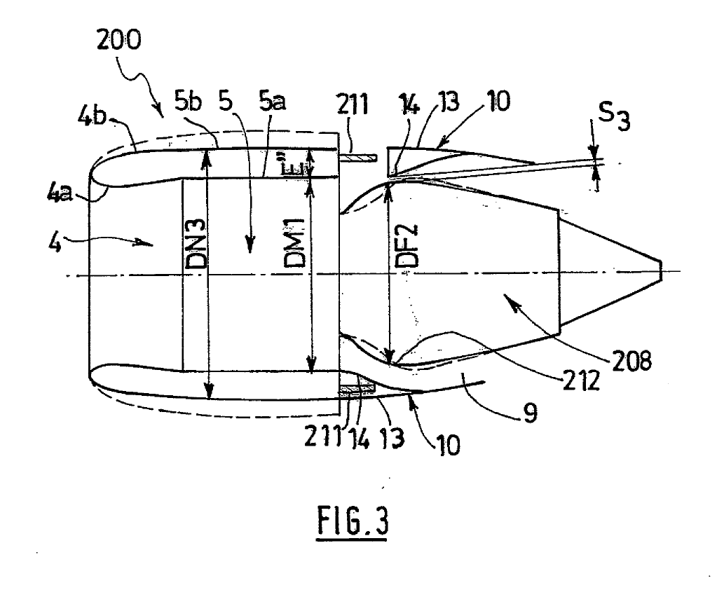

FIG. 3 is schematic view in longitudinal section of a nacelle of a bypass turbine engine with a high bypass ratio according to a second alternative form of embodiment of the invention.

Before describing an embodiment of the invention in detail, it is important to emphasize that the invention is not restricted to any particular type of reverser. Although it has been illustrated in the form of a cascade type reverser with moving cowls sliding along guide rails, it may just as easily be implemented with reversers of different designs, particularly of the clam shell door type.

FIG. 1 depicts a nacelle 1 for a bypass turbine engine with a high bypass ratio according to the prior art.

The nacelle 1 is intended to form a tubular housing for a bypass turbine engine (not depicted) with a high bypass ratio and serves to duct the air streams that it generates via the blades of a fan (not depicted), mainly a hot air stream passing through a combustion chamber (not depicted) of the turbine engine, and a cold air stream flowing around the outside of the turbine engine.

The nacelle 1 has a structure comprising a forward section that forms an air intake 4, a central section 5 surrounding the fan of the turbine engine, and a rear section surrounding the turbine engine and comprising a thrust reversal system.

The air intake 4 has an internal surface 4a intended to duct the incoming air and an external shroud surface 4b.

The central section 5 comprises, on the one hand, an internal casing 5a surrounding the fan of the turbine engine and, on the other hand, an external structure 5b shrouding the casing and extending the external surface 4b of the air intake section 4. The casing 5a is attached to the air intake section 4 that it supports and extends internal surface 4a thereof.

The rear section comprises an external structure comprising a thrust reversal system and an internal engine-shrouding structure 8, that defines, with the external surface, a duct 9 through which a cold stream is intended to flow in the case of a nacelle 1 for a bypass turbine engine like the one depicted here.

The thrust reversal system comprises a moving cowl 10 capable of translational movement so that it can move alternately, on the one hand, from a closed position in which it houses the deflection cascades 11 and provides structural continuity of the central section 5, thus allowing the cold stream 3 to be discharged through the duct 9 as a direct jet 3a and, on the other hand, into an open position in which it uncovers the deflection cascades 11, thus opening a passage in the nacelle 1, and blocks off the duct 9 downstream of the deflection cascades 11 thus allowing the cold stream to be reoriented into a reverse jet 3b.

More specifically, the cascade-type thrust reversal system depicted here is a natural blockage cascade thrust reversal system. That means that the moving cowl 10 naturally blocks off the duct 9 in the open position without the need for there to be any additional blocking doors.

To do this, the internal structure 8 of the rear section has, downstream of the deflection cascades 11, a bulge 12 that is substantial enough that it practically reaches the casing 5a of the nacelle 1. Thus, the inside diameter DM1 of the nacelle 1 at the outlet from the casing 5a of the central section 5 is substantially equal to the diameter DF1 of the internal structure 8 in the region of the bulge 12.

To supplement this arrangement, the moving cowl 10 has, on the one hand, an external wall 13 capable of providing the external structural continuity of the nacelle 1 with the external structure 5b of the shroud of the casing 5a and, on the other hand, an internal wall 14 capable of providing the internal structural continuity of the nacelle 1 with the casing 5a, the internal wall 14 substantially following the curvature of the internal structure 8 so that the duct 9 maintains a substantially constant cross section and therefore has a recess corresponding to the bulge 12. Furthermore, the internal wall 14 and the external wall 13 meet downstream of the moving cowl 10 to form a jet pipe capable of ejecting the cold stream at the desired angle.

Thus, in the open position, the moving cowl 10 completely blocks off the duct 9, the bulge 12 bringing the internal structure 8 practically into contact with an upstream part of said moving cowl 10, give or take the functional operating clearance.

The need to house the recess of the internal wall 14 of the moving cowl while at the same time ensuring the aerodynamics of the nacelle requires there to be a greater thickness between the external structures and the internal structures. Further, because all of the cold stream is blocked when the moving cowl 10 is in the open position, the nacelle has a cold stream deflection section that is large so that it is able to deflect a large proportion of this cold stream. This entails the presence of larger deflection cascades 11, leading to a greater opening length for the moving cowl 10 and a corresponding thickness and interior volume in which to house the deflection cascades 11 when the moving cowl 10 is in the closed position.

This greater bulk also results in a greater mass and in difficulties in housing such a nacelle for a turbine engine with a high bypass ratio under the wing of an airplane.

The invention underlying the present application aims to provide a solution to this bulk and increase in mass.

The principle of the invention relies on the fact that nacelles intended for turbine engines with high bypass ratios have, because of their size, a greater natural resistance which tends to brake the airplane. This resistance is known as the ram drag. As a result, there is no longer any need to optimize the thrust reversal by deflecting the maximum amount of the cold air stream toward the front of the nacelle.

The solution afforded by the invention lies in the fact that, during the thrust reversal phase, some of the cold stream is kept as an escaping direct jet thus making it possible to reduce the size of the reversal means, this secondary stream leakage cross section being controlled and determined in order to ensure just enough reversal.

FIGS. 2 and 3 depict two embodiments of the invention.

FIG. 2 depicts a first solution that consists in keeping the bulge 12 of a nacelle 1 according to the prior art but with a shorter length of deflection cascades and a corresponding reduction in the length over which the moving cowl 10 opens.

Hence, a nacelle 100 differs from the nacelle 1 solely in that it comprises deflection cascades 111 that are shorter in length than the deflection cascades 11 of the nacelle 1. The diameter DF 1 of the internal structure 8 at the bulge 12 is still substantially equal to the inside diameter DM1 of the casing 5a at the outlet of the central section 5.

The reduced length of the deflection cascades 111 allows for a lesser movement of the moving cowl 10 as the thrust reversal system opens. As a result, the upstream part of the moving cowl 10 no longer comes practically into contact with the bulge 12 but stops upstream of said bulge 12, thereby creating a leakage cross section S2 in the duct 9 between the moving cowl 10 and the internal structure 8. Further, because the deflection cascades 111 are not as difficult to house inside the moving cowl 10 in the closed position, the total thickness of the moving cowl 10 upstream thereof can be reduced by comparison with the prior art. This accordingly makes it possible to reduce the overall thickness E′ of the nacelle, namely the distance between the casing 5a and the external structure Sb of the central section 5, this reduction in thickness E′ naturally having repercussions on the air intake section 4 and resulting in an overall reduction in the overall diameter DN2 of the nacelle 111 by comparison with the diameter DN1 of a nacelle 1 of thickness E.

Furthermore, the shorter opening length of the moving cowl 10 allows for a reduction in the length of the guide rails (not visible) that guide said moving cowl 10, installed at the top and bottom of the thrust reverser structure. This leads to a reduction in the streamlining shroud of said guide rails and this also makes it possible to reduce the overall dimensions of the moving cowl 10 and, as a result, to minimize discontinuities in the aerodynamic profile, thus gaining in terms of efficiency. Because the guide rails are shorter than on a thrust reversal system according to the prior art, they can be brought back as far as possible toward the extrados side of the moving cowl 10, thus eliminating or reducing part of the flat that lies in the duct 9 in the region of the internal wall 14 of the moving cowl 10 generally encountered where the guide rail passes through.

The outline of the nacelle 1 is depicted in broken line in FIG. 2, for the purposes of comparison.

FIG. 3 shows a second solution that consists in reducing the height of the bulge 12 of a nacelle 1 according to the prior art and in positioning it further upstream.

Thus, a nacelle 200 differs from the nacelle 1 in that it comprises an internal structure 208 that has a less substantial bulge 212 positioned further upstream than the bulge 12 of the nacelle 1.

As a result, the diameter DF2 of the internal structure 208 in the region of the bulge 212 is smaller than the inside diameter DM1 of the casing 5a. That naturally allows a space to be created between the bulge 212 and the moving cowl 10 in the open position, this space constituting a leakage cross section S3 for the cold air stream. Like with the nacelle 1, the moving cowl 10 moves as far as the boss 212. Because this boss is situated further upstream than the boss 12 of the prior art, the length of travel of the moving cowl 10 is shorter and houses deflection cascades 211 that are also shorter because there is less cold air stream 3b to deflect. The consequences on the overall sizing of the nacelle are the same as those explained in respect of the nacelle 100.

However, because the bulge 212 is not as substantial, the recess formed by the internal wall 14 of the moving cowl 10 is also less substantial. The internal wall 14 therefore has less curvature making it possible further to reduce the separation between the internal wall 14 and the external wall 13 of the moving cowl upstream of this bulge and therefore the overall dimensions of the nacelle 200 by comparison with the nacelle 1.

The outline of the nacelle 1 is depicted in broken line in FIG. 3 for the purposes of comparison.

Just as with the nacelle 100, the shorter opening length of the moving cowl 10 allows for a reduction in the length of the guide rails (not visible) that guide said moving cowl 10. This leads to a reduction in the streamlining shrouding said guide rails which also makes it possible to reduce the overall dimensions of the moving cowl 10 and, as a result, to minimize the discontinuities of the aerodynamic profile, thus gaining efficiency. Because the guide rails are shorter than on a thrust reversal system according to the prior art, they can be brought back as far as possible toward the extrados side of the moving cowl 10, thus eliminating or reducing part of the flat located in the duct 9 in the region of the internal wall 14 of the moving cowl 10 that is customarily encountered where the guide rails pass through.

In general, the leakage cross sections S2, S3 increase with bypass ratio and so for a turbine engine with a higher bypass ratio, the leakage cross section S2, S3 will be increased.

Furthermore, in order to avoid any build up of airflow in the duct 9 that could lead to a rise in pressure or more generally to any variation in pressure in the duct 9, the leakage cross section S2, S3 and the deflection cross section are calculated so that their sum is substantially equal to the cross section of the duct 9 in direct jet mode.

The effectiveness of the reversal obtained is dependent on the ratio of the leakage cross section S2, S3 to the discharge cross section in direct jet mode. Thus, for a bypass turbine engine with a bypass ratio of 10, it has been calculated that a reversal efficiency that generates a reverse flow that produces a reverse thrust substantially equal to 20% of the thrust generated by the secondary stream in direct jet mode is sufficient. A reversal efficiency such as this corresponds to a leakage cross section S2, S3 approximately equal to 30% of the discharge cross section in direct jet mode.

Although the invention has been described with specific embodiments, it is quite obvious that it is not in any way restricted thereto and that it encompasses all technical equivalents of the means described and combinations thereof where these fall within the scope of the invention.

1. A nacelle for a bypass turbine engine with a high bypass ratio comprising an inner duct through which there flows a secondary stream generated by the turbine engine and which has an external structure equipped with a thrust reverser device capable alternately of switching from a closed position in which it allows the secondary stream to flow through the inner duct as a direct jet, into an open position in which it uncovers an opening in the external structure so as to allow the secondary stream to be redirected into a deflected jet through activation of thrust reverser means, the thrust reverser device, in the open position, partially blocking the inner duct so as to create therein a leakage cross section allowing a controlled leakage flow, said nacelle being characterized in that, when in the open position, the thrust reverser has a cross section for reversal into a deflected jet and a leakage cross section for leakage through the inner duct the sum of which is substantially equal to a cross section for discharging the secondary stream as a direct jet when the thrust reverser is in the closed position.

2. The nacelle as claimed in claim 1, characterized in that the reversal cross section is obtained by moving a moving cowl of reduced thickness and capable, in the closed position, of ensuring the external and internal aerodynamic continuity of the nacelle.

3. The nacelle as claimed in claim 1, characterized in that it is intended to house a turbine engine with a bypass ratio of close to ten, and in that the leakage cross section is calculated so that the thrust reverser, in the open position, provides a reverse thrust substantially equal to twenty percent of the direct-jet thrust obtained when the reverser is in the closed position.

4. The nacelle as claimed in claim 1, characterized in that the leakage cross section represents approximately thirty percent of the discharge cross section for direct jet discharge.

5. The nacelle as claimed in claim 1, characterized in that the thrust reverser is a cascade-type thrust reverser with cascades.

6. The nacelle as claimed in claim 5, characterized in that the thrust reverser is a natural blockage cascade reverser.

7. The nacelle as claimed in claim 6, characterized in that the leakage cross section is obtained by reducing the cross section of the inner duct as a moving cowl with which the thrust reverser device is equipped is moved.

8. The nacelle as claimed in claim 7, characterized in that the inner duct has a bulge situated downstream of the moving cowl in the open position.

9. The nacelle as claimed in claim 8, characterized in that the inner duct has a bulge situated substantially in the region of an upstream edge of the moving cowl in the open position.
